(19) United States
(12) Patent Application Publication
(10) Pub. No.: US 2010/0296686 A1
(43) Pub. Date: Nov. 25, 2010

(54) SPEAKER APPARATUS

(75) Inventors: Ritsuo Machii, Tokyo (JP); Masahiro Ando, Yokohama-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/779,571

(22) Filed: May 13, 2010

(30) Foreign Application Priority Data
May 22, 2009 (JP) 2009-124722

(51) Int. Cl. H04R 1/02

(52) U.S. Cl. 381/387

(57) ABSTRACT

A speaker apparatus includes a speaker unit arranged to output sound to the exterior of the speaker apparatus via an opening; an enclosure containing the speaker unit; and a protection units, supported by the enclosure, for protecting the speaker unit, wherein the protection units includes a protection member for at least partially covering the opening, and wherein the apparatus comprises moving unit for changing the distance between the enclosure and the protection units and wherein the protection units is configured such that the position of the protection member changes with respect to the opening in accordance with a change in the distance between the enclosure and the protection units.

### BACKGROUND OF THE INVENTION

1. Field of the Invention

The present invention relates to a cover that protects a speaker unit included in a speaker apparatus.

2. Description of the Related Art

In audio-related industries, the digitization of reproduced music sources and acoustic equipment has enabled the transmission of high-quality acoustic signals, and this has been accompanied by a desire for speaker apparatuses that can faithfully reproduce such acoustic signals.

In a speaker apparatus that includes a speaker unit, it is preferable for the outer surface of the enclosure to be smooth during use, in order to improve the quality of the sound output from the speaker unit. By mounting the speaker unit in an opening portion of the enclosure and inputting an electrical signal thereto, or providing corner portions of the enclosure with tapered portions, it is possible to suppress the level of sound waves that are generated due to the sound radiated from the speaker unit being diffracted by the corner portions of the enclosure. As a result, it is possible to suppress disturbances in the sound pressure and frequency characteristics that occur due to interference between sound waves generated by sound diffraction and sound waves radiated from the diaphragm of the speaker unit, thus realizing even sound pressure and frequency characteristics. However, if the speaker is covered in order to prevent it from, for example, becoming damaged or dirty, the outer surface of the enclosure ends up having unevenness, which adversely influences the sound quality.

In the example of a radio/cassette apparatus disclosed in Japanese Patent Laid-Open No. 6-121384, the speaker unit is mounted on a face that is recessed by one level, and a shutter is placed inside the speaker enclosure. The shutter is configured so as to be able to move along the front lateral face, top lateral face, and back lateral face of the speaker enclosure.

In Japanese Patent Laid-Open No. 6-121384, the shutter can move toward the back of the speaker unit so as to expose the speaker unit when the radio/cassette apparatus is used. However, since shutter-supporting members and the like protrude out farther than the face to which the speaker unit is mounted, there is the disadvantage that the sound radiated from the speaker unit is diffracted by the edge lines of the shutter-supporting members and the like, which influences the sound quality.

### SUMMARY OF THE INVENTION

The present invention provides a speaker apparatus in which the speaker is open during use, and a speaker is protected during non-use, whilst minimizing the occurrence of sound diffraction, and with minimal influence on the sound quality.

The present invention provides a speaker apparatus comprising: a speaker unit arranged to output sound to the exterior of the speaker apparatus via an opening; an enclosure containing the speaker unit; and a protection units, supported by the enclosure, for protecting the speaker unit, wherein the protection units includes a protection member for at least partially covering the opening, and wherein the apparatus comprises moving unit for changing the distance between the enclosure and the protection units and wherein the protection units is configured such that the position of the protection member changes with respect to the opening in accordance with a change in the distance between the enclosure and the protection units.

Further features of the present invention will become apparent from the following description of exemplary embodiments with reference to the attached drawings.

### BRIEF DESCRIPTION OF THE DRAWINGS

FIG. 1 is a perspective diagram showing an open position of a protection unit in a speaker apparatus having a protection unit according to Embodiment 1.

FIG. 2 is a perspective diagram showing a closed position of a protection unit in the speaker apparatus having a protection unit according to Embodiment 1.

FIG. 3 is a perspective diagram showing the protection units according to Embodiment 1.

FIG. 4 is a schematic diagram showing the protection units in the open position according to Embodiment 1.

FIG. 5 is a schematic diagram showing the protection units in the closed position according to Embodiment 1.

FIG. 6 is a detailed view of a portion V in FIG. 3 according to Embodiment 1.

FIG. 7 is a cross-sectional view taken along W-W in FIG. 3 according to Embodiment 1.

FIG. 8 is a perspective diagram showing an open position of a protection unit in a speaker apparatus having a protection unit according to Embodiment 2.

FIG. 9 is a perspective diagram showing a closed position of a protection unit in the speaker apparatus having a protection unit according to Embodiment 2.

FIG. 10 is a schematic diagram showing a protection unit in the closed position according to Embodiment 2.

FIG. 11 is a schematic diagram showing the protection units during operational movement from the open position to the closed position according to Embodiment 2.

FIG. 12 is a schematic diagram showing the protection units in the closed position according to Embodiment 2.

FIG. 13 is a schematic diagram showing a protection unit in an open position according to Embodiment 3.

FIG. 14 is a schematic diagram showing the protection units in a closed position according to Embodiment 3.

### DESCRIPTION OF THE EMBODIMENTS

Below is a detailed description of embodiments of the present invention with reference to the drawings.

### Embodiment 1

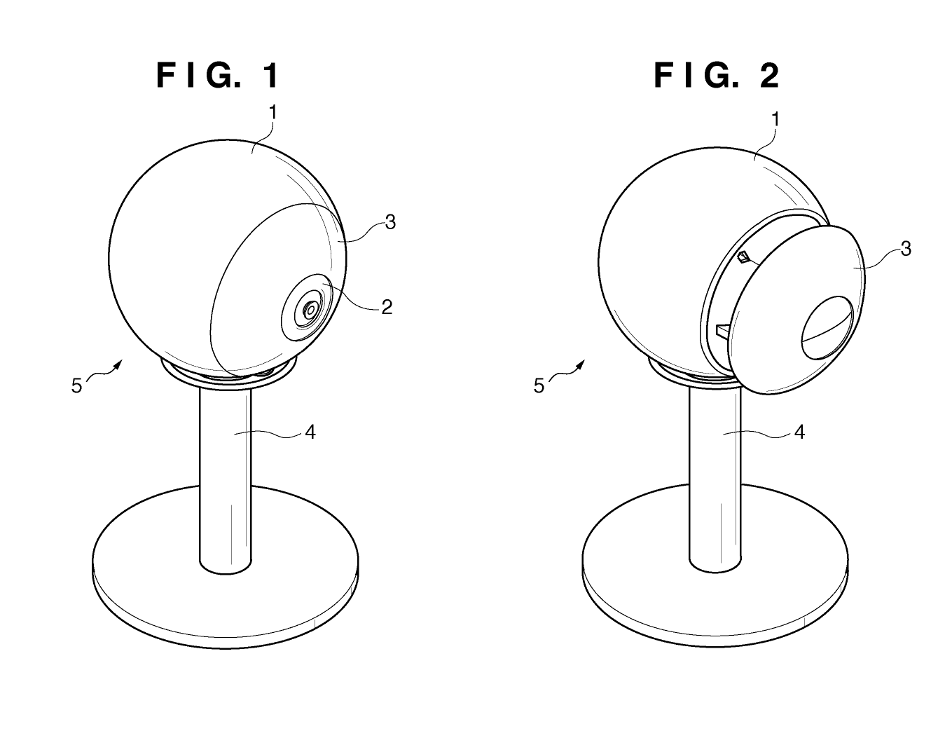

FIG. 1 is a perspective diagram showing a protection unit open position in a speaker apparatus having a protection unit according to Embodiment 1 of the present invention.

FIG. 2 is a perspective diagram showing a protection unit closed position in the speaker apparatus shown in FIG. 1.

In FIGS. 1 and 2, a speaker apparatus 5 having a protection unit 3 of the present embodiment includes a spherical enclosure 1 in which a speaker unit 2 is contained, and the speaker unit 2 contained in the enclosure 1. The speaker apparatus 5 further includes the protection unit 3 that covers the speaker unit 2, and a speaker stand 4 that places at ear level the enclosure 1 in which the speaker unit 2 is mounted.

As shown in FIG. 1, the protection unit 3 forms a portion of the outer surface of the enclosure 1 so as to reduce the occurrence of the diffraction of sound output from the speaker unit to the exterior when the protection unit 3 is in an open position. The protection unit 3 has a mechanism that enables the distance to the enclosure 1 to be variable (so the protection unit can be moved away from the enclosure, towards the exterior, and back towards the enclosure), and the opening state of an opening portion can be controlled by such mechanism. In other words, as shown in FIG. 2, when in a closed position, the protection unit 3 has moved forward and changed the opening state of the opening portion, and covers the speaker unit 2, thus protecting the speaker unit 2.

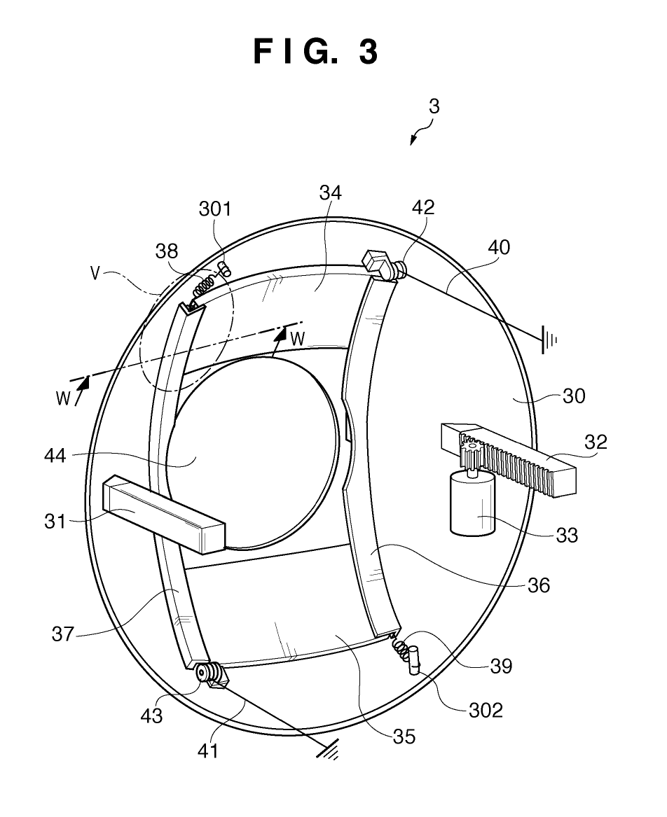

FIG. 3 is a perspective diagram showing the protection unit according to Embodiment 1 of the present invention. The following describes a configuration of the protection unit with reference to FIG. 3.

The protection unit 3 has a protection cover 30 that forms a portion of the outer surface of the enclosure, and the protection unit 3 is supported by the enclosure 1 shown in FIG. 1 via a support member 31 and a rack-provided support member 32 (so a support member provided with a rack) that are mounted to the protection cover 30, which has an opening (portion) 44. The rack-provided support member 32 is engaged with a gear-provided motor 33 (so a motor provided with a pinion), and is mounted inside the enclosure 1. Also, the protection unit 3 has protection members 34 and 35 that can cover the speaker unit 2 (by substantially or wholly covering the opening 44). The protection members 34 and 35 are guided by guide members 36 and 37 so as to be able to move from the open position to the closed position. The guide portion is bilaterally symmetrical, and therefore only the configuration of one side of the guide portion will be described in detail.

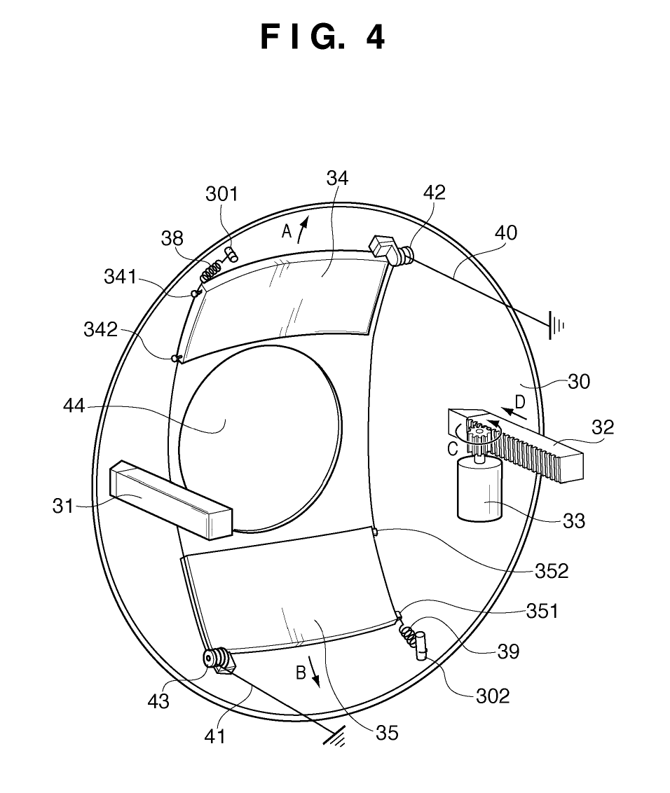

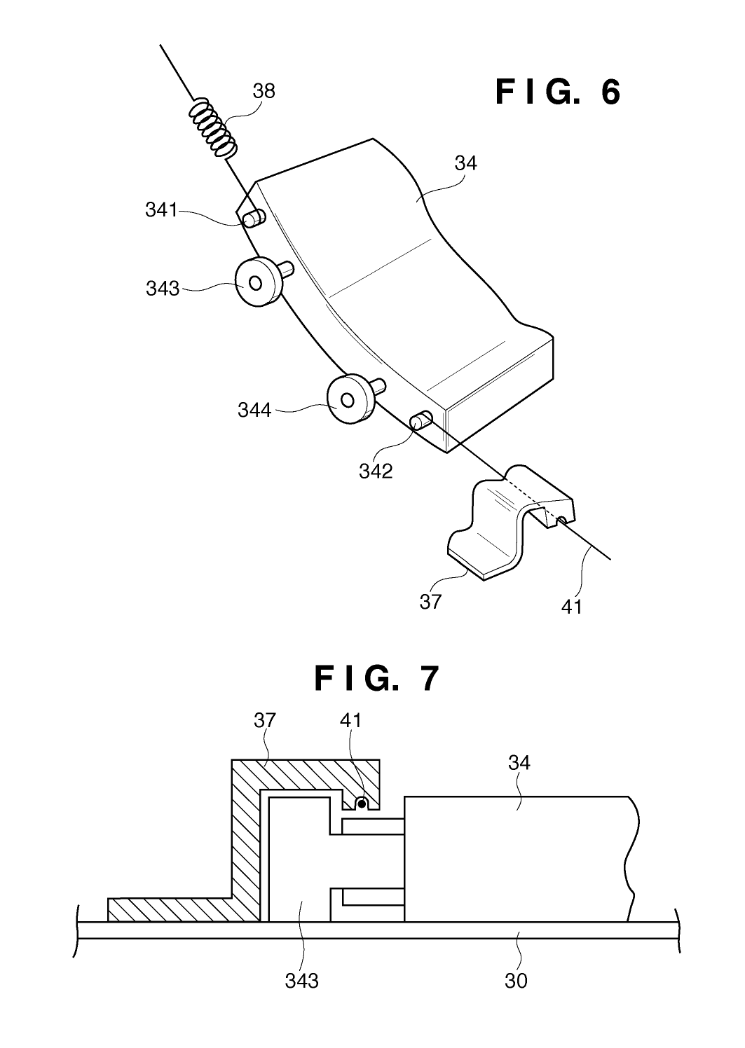

FIG. 4 is a schematic diagram showing the protection unit in the open position. Although the guide members 36 and 37 shown in FIG. 3 have been omitted for convenience from FIG. 4, details of the guide members are illustrated in FIGS. 6 and 7.

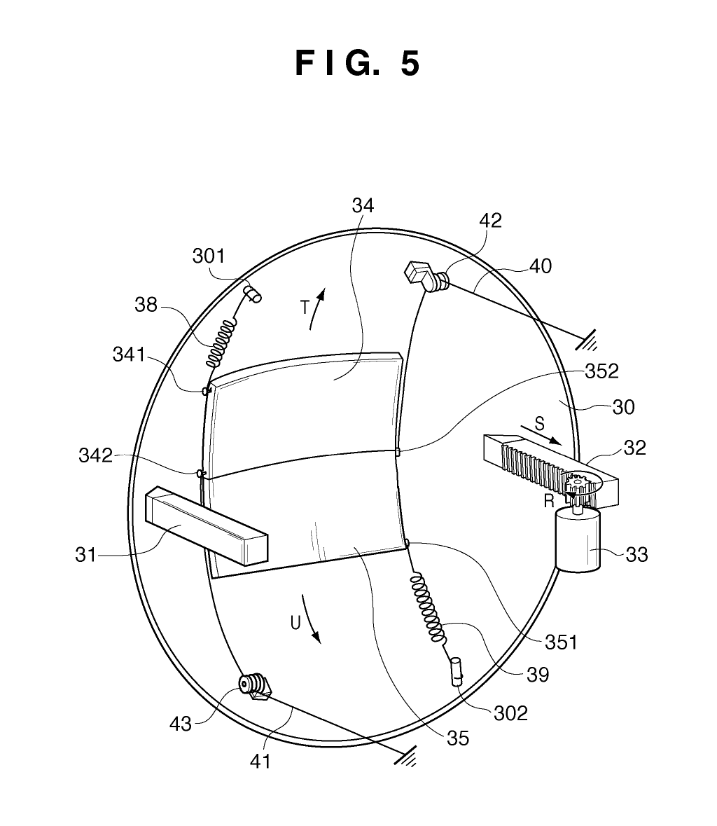

FIG. 5 is a schematic diagram showing the protection unit in the closed position.

FIG. 6 is a diagram showing details of a portion V in FIG. 3, that is to say, a diagram showing details of the guide portion.

FIG. 7 is a cross-sectional diagram showing details of a portion along W-W in FIG. 3, that is to say, a diagram showing details of the guide portion. FIG. 7 shows one side of the protection member 34. The following describes portions of the protection unit with reference to FIGS. 4 to 7.

As shown in FIGS. 6 and 7, the guide member 37 has a recessed portion that guides rollers 343 and 344, and a groove that guides a connecting means, in particular wire 41. The rollers 343 and 344 are rotatably mounted to a lateral face of the protection member 34, and are guided by the recessed portion of the guide member 37.

The wire 41 is guided by the groove of the guide member 37 shown in FIG. 7. Note that the guide member 36 shown in FIG. 3 has a similar configuration to that of the guide member 37. As shown in FIGS. 4 and 5, end portions of biasing means, in particular springs 38 and 39 on one side are locked to spring holding means, in particular pins 341 and 351, that are implanted in the protection members 34 and 35, and thus the spring holding pins 341 and 351 are biased in the direction toward the open position. Note that the springs 38 and 39 are supported by spring holding pins 301 and 302 that are implanted in the protection cover 30.

As shown in FIGS. 4 and 5, the two ends of an elongate connecting means, in particular wire 40, are respectively locked to a wire holding means, in particular a pin 352 that is implanted in the protection member 35 and to the inner side (not shown) of the enclosure 1. Also, the two ends of the elongate connecting means, in particular wire 41, are respectively locked to a holding means for holding the wire, in particular a pin 342 that is implanted in the protection member 34 and to the inner side (not shown) of the enclosure. The wires 40 and 41 are guided by guide means, in particular the grooves of the guide members 36 and 37, and are locked as described above via pulleys 42 and 43. The pulleys 42 and 43 have grooves to which the wires 40 and 41 are caused to fit in, and the pulleys 42 and 43 are connected to the protection cover 30 such that they can rotate.

Next is a description of operations of the protection unit 3 of the speaker apparatus 5 having the above configuration, starting with a description of the open position, and then a closing operation.

First is a description of the open position. The open state is realized by moving the positions of the protection members such that the opening portion is sufficiently open, so that sound output from the speaker unit is not obstructed by the opening portion (in particular is not obstructed by the protection members 34 and 35). FIG. 1 shows a protection unit open position in the speaker apparatus 5 having the protection unit 3 according to Embodiment 1, and FIG. 4 shows the protection unit 3 in the open position.

When the protection unit 3 is in the open position, at respective ends of the protection members 34 and 35, the spring holding pins 341 and 351 of the protection members 34 and 35 are biased by the springs 38 and 39, and thus the protection members 34 and 35 are biased in the directions of arrows A and B respectively. At the other respective ends of the protection members 34 and 35, the wire holding pins 342 and 352 of the protection members 34 and 35 are locked by the wires 40 and 41. According to this configuration, the protection members 34 and 35 are at rest at positions at which a balance is achieved between the biasing force of the springs 38 and 39 and the tensile force of the wires 40 and 41, that is to say, open positions. In the state in which the protection unit 3 is in the open position shown in FIG. 4, the protection unit 3 forms a portion of the outer surface of the enclosure shown in FIG. 1.

Next is a description of the closing operation.

When the protection unit 3 is in the protection unit open position shown in FIG. 4, the gear-provided motor 33 rotates in the direction of an arrow C, the rotational movement of the gear-provided motor 33 is transmitted to the rack-provided support member 32 via the gear and the rack, and the rack-provided support member 32 thus moves in the direction of an arrow D (so in a direction away from the enclosure and towards the exterior). As a result, the protection unit 3 moves forward with respect to the speaker unit 2 (and with respect to the enclosure 1). The wires 40 and 41 that are locked to the inner side of the enclosure 1 and to the protection members 34 and 35 have a constant length. Accordingly, as the protection unit 3 moves forward, there is an increase in the distance between the positions where the wires 40 and 41 are locked to the inner side of the enclosure 1 and the positions where the pulleys 42 and 43 are placed. As a result, there is a decrease in the distance between the positions where the wires 40 and 41 are locked to the wire holding pins 342 and 352 of the protection members 34 and 35 and the positions where the pulleys 42 and 43 are placed. Accordingly, the protection members 34 and 35 of the protection unit 3 move in directions opposite to the arrows A and B respectively, that is to say, in directions for covering the opening portion 44 of the protection cover 30. The distance that the protection unit 3 moves and the distance that the protection members 34 and 35 move when moving from the open position to the closed position are set to the same length. Accordingly, when the movement of the protection unit 3 is complete, the protection members 34 and 35 have moved to positions at which they completely cover the opening (portion) 44 of the protection cover 30. Such movement realizes the state of the protection unit 3 in the closed position shown in FIG. 5, and enables protecting the speaker unit 2 as shown in FIG. 2.

Next is a description of an opening operation.

FIG. 2 shows the closed position of the protection unit in the speaker apparatus 5 having the protection unit 3 according to Embodiment 1 of the present invention. Also, FIG. 5 shows the protection unit 3 in the closed position.

When the protection unit 3 is in the closed position, the gear-provided motor 33 rotates in the direction of an arrow R, the rotational movement of the gear-provided motor 33 is transmitted to the rack-provided support member 32 via the gear and the rack, and thus the rack-provided support member 32 moves in the direction of an arrow S. The protection unit 3 therefore moves in a direction for approaching the speaker unit 2. Here, the wires 40 and 41 that are locked to the inner side of the enclosure 1 and to the protection members 34 and 35 have a constant length. Accordingly, as the protection unit 3 moves in the direction for approaching the speaker unit 2, there is a decrease in the distance between the positions where the wires 40 and 41 are locked to the inner side of the enclosure 1 and the positions where the pulleys 42 and 43 are placed. Conversely, there is an increase in the distance between the positions where the wires 40 and 41 are locked to the wire holding pins 342 and 352 of the protection members 34 and 35 and the positions where the pulleys 42 and 43 are placed.

As a result, the protection members 34 and 35 of the protection unit 3 move in the directions of arrows T and U respectively, that is to say, directions for exposing the opening portion 44 of the protection cover 30. The distance that the protection unit 3 moves and the distance that the protection members 34 and 35 move when moving from the closed position to the open position are set to the same length. For this reason, when the movement of the protection unit 3 is complete, the protection members 34 and 35 have moved to positions at which they completely expose the opening portion of the protection cover 30. This realizes the state of the protection unit 3 in the open position shown in FIG. 4. Accordingly, the protection unit 3 forms a portion of the outer surface of the enclosure shown in FIG. 1.

Although the embodiment has been described with respect to a protection unit having two protection members 34 and 35 the invention can also be implemented by having one single protection member. The distance that the protection unit moves is set accordingly so that the protection member covers the opening 44 when in the closed position.

### Embodiment 2

Below is a description of a speaker apparatus having protection units according to Embodiment 2 of the present invention. In this speaker apparatus having protection units, the enclosure is cubical.

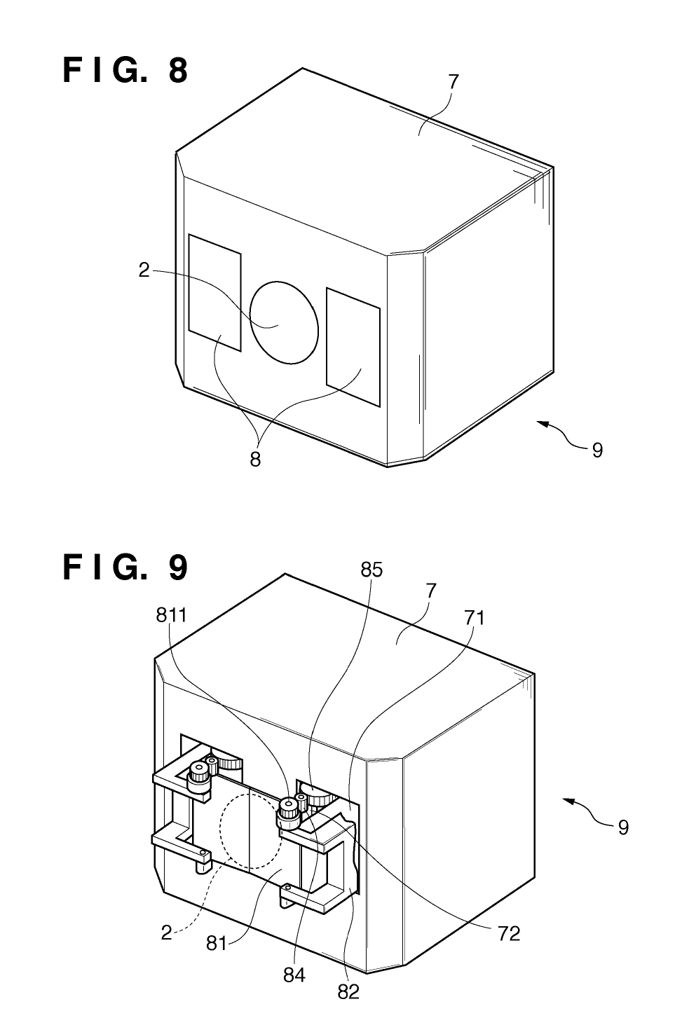

FIG. 8 is a perspective diagram showing a protection unit open position in the speaker apparatus having protection units according to Embodiment 2 of the present invention.

FIG. 9 is a perspective diagram showing a protection unit closed position in the speaker apparatus.

In FIGS. 8 and 9, a speaker apparatus 9 includes a cubical enclosure 7, a speaker unit 2 mounted in an opening portion of the enclosure 7, and protection units 8 that can cover the speaker unit 2.

As shown in FIG. 8, the protection units 8 form a portion of the outer surface of the enclosure so as to reduce the occurrence of the diffraction of sound when the protection units 8 are in the open position (so are positioned substantially flush with the outer surface of the enclosure such that their surfaces are in the same plane). As shown in FIG. 9, when in the closed position, the protection units 8 have moved forward and cover the speaker unit 2, and are in a state of protecting the speaker unit 2.

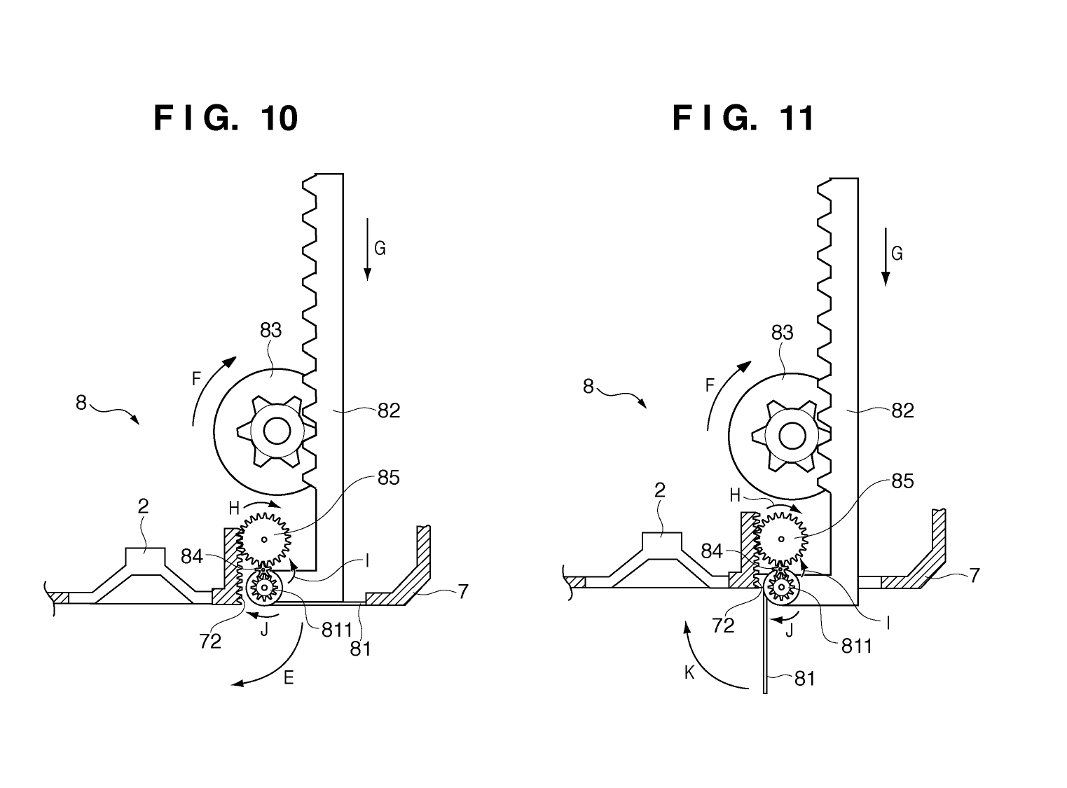

FIG. 10 is a schematic diagram showing a protection unit in the open position. The following describes a configuration of the protection units 8 with reference to FIGS. 9 and 10.

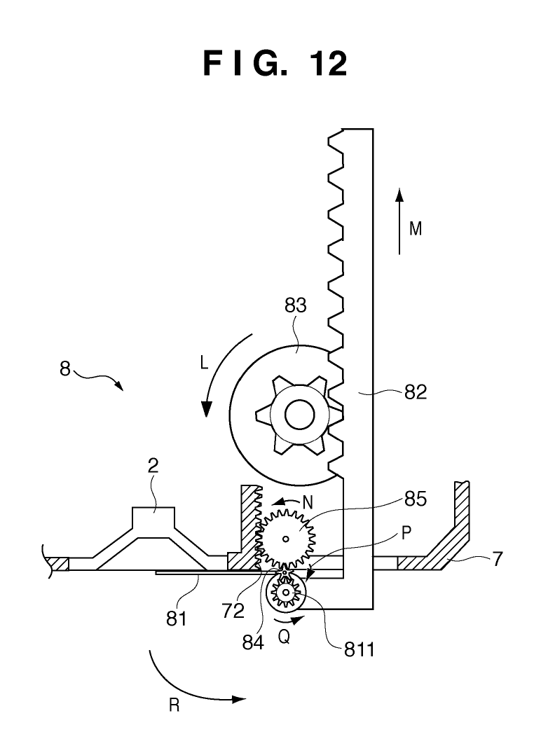

In the speaker apparatus 9 shown in FIG. 10, the protection units 8 are placed bilaterally symmetrically on the enclosure face that includes the opening portion in which the speaker unit 2 is mounted. First is a description of the protection unit 8 on the right side in FIG. 8, with reference to FIGS. 9 and 12.

The protection unit 8 forms a portion of the outer surface of the enclosure, and furthermore has a protection member 81 that covers the speaker unit 2, is stored in an opening portion 71, and is supported by the enclosure 7 via a support member 82 to which the protection member 81 is mounted. The support member 82 has a rack. The rack-provided support member 82 is engaged with a (pinion) gear-provided motor 83, and is supported to the enclosure 7.

The support member 82 has four shafts (not shown), two of which support the protection member 81, and two of which support gears 84 and 85. The protection member 81 has a gear portion 811 that is engaged with the gear 84. The gear 84 is engaged with the gear 85, and the gear 85 is engaged with a rack 72. The protection member 81 is rotatably supported by the shafts (not shown) described above, and the gears 84 and 85 are rotatably supported by the other shafts (not shown) described above. Note that the rack 72 is formed on the inner face of the enclosure 7.

Next is a description of operations of the protection units 8 of the speaker apparatus 9 having the above configuration, starting with a description of the open position, then a closing operation, and then an opening operation.

First is a description of the open position. FIG. 8 shows the protection unit open position in the speaker apparatus 9 having the protection units 8 according to Embodiment 2. FIG. 10 shows the protection unit 8 in the open position.

When the protection unit 8 is in the open position, the gear portion 811 of the protection member 81 is engaged with the gear 84, and therefore the protection member 81 is at rest in the position shown in FIG. 10, that is to say, the open position. As shown in FIG. 10, in the state in which the protection unit 8 is in the open position, the protection unit 8 forms a portion of the outer surface of the enclosure shown in FIG. 8.

Next is a description of the closing operation. When the protection unit 8 is in the protection unit open position shown in FIG. 10, the gear-provided motor 83 rotates in the direction of an arrow F, the rotational movement of the gear-provided motor 83 is transmitted to the support member 82 via the gear and the rack, and the support member 82 thus moves in the direction of an arrow G. Due to the support member 82 moving in the direction of the arrow G, the gear 85 rotates in the direction of an arrow H, that power is transmitted to the gear 84, and thus the gear 84 rotates in the direction of an arrow I. Due to the gear 84 rotating in the direction of the arrow I, the gear portion 811 of the protection member 81 rotates in the direction of an arrow J, and thus the protection member 81 moves forward with respect to the speaker unit 2, and furthermore rotates in the direction of an arrow E.

FIG. 11 is a schematic diagram showing the protection unit during operational movement from the open position to the closed position. Also, FIG. 12 is a schematic diagram showing the protection unit in the closed position.

As shown in FIG. 11, the protection member 81 further rotates in the direction of an arrow K, thus rotating to a position at which the protection member 81 (partially) covers the speaker unit 2 (see FIG. 12). When this operation is complete, the state in which the protection unit 8 is in the closed position as shown in FIG. 12 is realized, and thus the protection unit 8 can protect the speaker unit 2 as shown in FIG. 9.

Next is a description of the opening operation performed when the protection units 8 are in the closed state. FIG. 9 shows the protection unit closed position in the speaker apparatus 9 having the protection units 8 according to Embodiment 2 of the present invention. Also, FIG. 12 shows the protection unit 8 in the closed position.

When the protection unit 8 is in the closed position shown in FIG. 12, the gear-provided motor 83 rotates in the direction of an arrow L, the rotational movement of the gear-provided motor 83 is transmitted to the support member 82 via the gear and the rack, and the support member 82 thus moves in the direction of an arrow M. Due to the support member 82 moving in the direction of the arrow M, the gear 85 rotates in the direction of an arrow N, that power is transmitted to the gear 84, and thus the gear 84 rotates in the direction of an arrow P. Due to the gear 84 rotating in the direction of the arrow P, the gear portion 811 of the protection member 81 rotates in the direction of an arrow Q, and thus the protection member 81 moves in a direction for approaching the plane of the speaker unit 2, and furthermore rotates in the direction of an arrow R. When this operation is complete, the state in which the protection unit 8 is in the open position as shown in FIG. 10 is realized, and thus the protection unit 8 can form a portion of the outer surface of the enclosure as shown in FIG. 8.

As described above, according to the present embodiment, the protection units 8 can move between the open position at which the protection units 8 expose the front face of the speaker unit 2, and the closed position at which the protection units 8 cover the front face of the speaker unit 2. Furthermore, the protection units 8 are configured so as to form a portion of the outer surface of the enclosure when in the open position, and therefore the speaker unit 2 is protected by the protection units 8 during non-use. As a result, the opening rate can be set to 100% during use, and furthermore the occurrence of the diffraction of sound can be reduced.

Although this embodiment has been described with respect to two protection units each having a protection member 81 or 82 a further embodiment has one single protection unit having one single protection member. The size of the protection member is set accordingly so that the protection member fully covers the opening 44 when in the closed position.

### Embodiment 3

Below is a description of a speaker apparatus having a protection unit according to Embodiment 3 of the present invention.

In the speaker apparatus 5 according to the present embodiment, a power supply that supplies power to a motor for moving the movable mechanism portions in the protection unit is automatically turned on when the speaker apparatus 5 is to be used, and therefore the motor rotates in a direction such that the opening portion opens, and protection members 34 and 35 open. Similarly, the speaker apparatus 5 is configured such that when the speaker apparatus is not used, the power supply that supplies power to the movable mechanism portions is automatically turned on, and therefore the motor rotates in a direction such that the opening portion closes, and the protection members 34 and 35 close. The present embodiment is the same as Embodiment 1, with the provision of an open position detection switch 353 and a closed position detection switch 354 that respectively detect that the protection members are in the open position and the closed position.

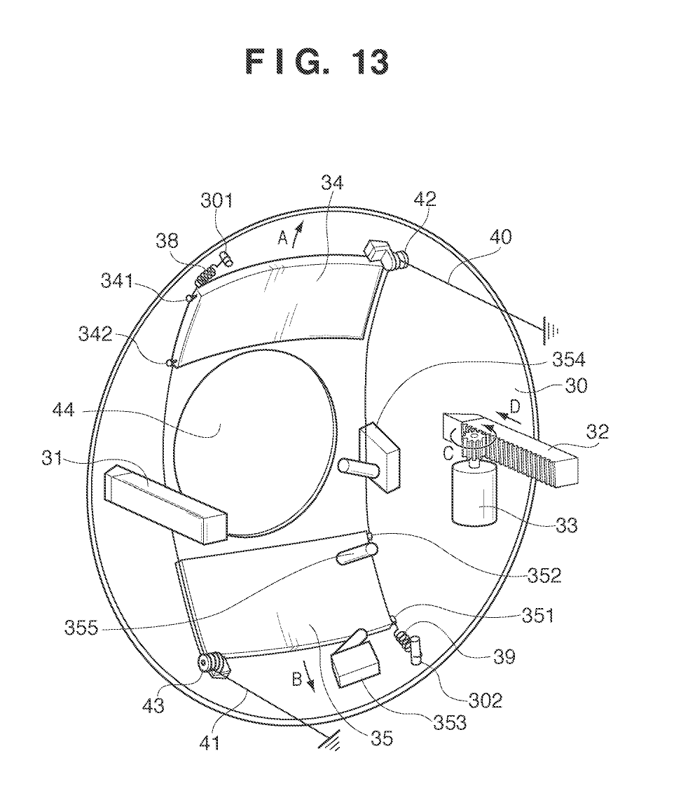

FIG. 13 is a diagram showing the protection unit 3 according to Embodiment 3 of the present invention. More specifically, FIG. 13 is a schematic diagram showing the protection unit in the open position described in Embodiment 1 (note that the guide members 36 and 37 have been omitted for convenience).

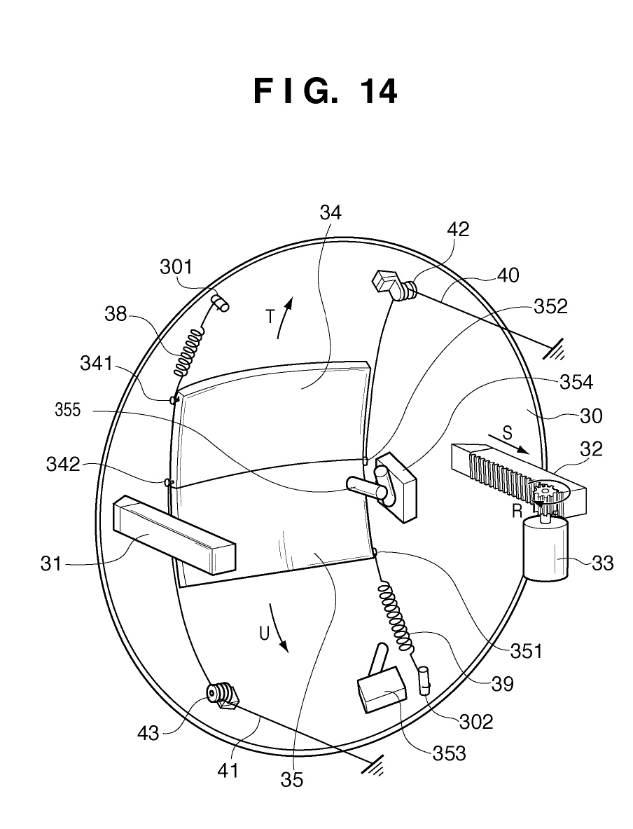

FIG. 14 is a schematic diagram showing the protection unit in the closed position (note that the guide members 36 and 37 have been omitted).

Next is a description of the configuration according to Embodiment 3 that has been added to Embodiment 1 with reference to FIGS. 14 and 13. Note that a description of the configuration described in Embodiment 1 is not repeated.

The open position detection switch 353 is mounted to the protection cover 30 so as to abut against a lateral face of the protection member 35 when the protection members are in the open position. The closed position detection switch 354 is mounted to the protection cover 30 so as to abut against a projecting portion, in particular pin 355, when the protection members are in the closed position. The pin 355 projects out from the back face of the protection member 35.

Next is a description of operations of the protection unit 3 of the speaker apparatus 5 having the above configuration, starting with a description of turning on a main power supply, and then turning off the main power supply.

First is a description of an operation for turning on the main power supply. Here, FIG. 2 shows the protection unit closed position in the speaker apparatus 5 having the protection unit 3 according to Embodiment 3. Also, FIG. 14 shows the protection unit 3 in the closed position.

When the protection unit 3 is in the closed position, the closed position detection switch 354 is pressed by the pin 355 projecting out from the back face of the protection member 35, and the closed position detection switch 354 is detecting “ON”. When the protection unit 3 is in this position and the main power supply is turned on, the gear-provided motor 33 rotates and the opening operation continues until the open position detection switch 353 detects that the protection members are in the open position. The opening operation is described in Embodiment 1, and therefore a description thereof has been omitted from the present embodiment. The open position detection switch 353 is pressed by a lateral face of the protection member 35 and detects that the protection members are in the open position, and immediately thereafter stops the rotation of the gear-provided motor 33, thus ending the opening operation. When the opening operation is complete, the protection members 34 and 35 have moved to a position at which they completely expose the opening portion of the protection cover 30, and therefore the state in which the protection unit 3 is in the open position as shown in FIG. 13 is realized, and the protection unit 3 forms a portion of the outer surface of the enclosure shown in FIG. 1.

Next is a description of an operation for turning off the main power supply. FIG. 1 shows the protection unit open position in the speaker apparatus 5 having the protection unit 3 according to Embodiment 3 of the present invention. Also, FIG. 13 shows the protection unit 3 in the open position.

When the protection unit 3 is in the open position, the open position detection switch 353 is pressed by a lateral face of the protection member 35, and the open position detection switch 353 detects that the protection members are in the open position.

When the protection unit 3 is in this position and the main power supply is turned off, the gear-provided motor 33 rotates and the closing operation continues until the closed position detection switch 354 detects that the protection members are in the closed position. The closing operation is described in Embodiment 1, and therefore a description thereof has been omitted from the present embodiment. The closed position detection switch 354 is pressed by the pin 355 projecting out from the back face of the protection member 35 and detects that the protection members are in the closed position, and immediately thereafter stops the rotation of the gear-provided motor 33, thus ending the closing operation. When the closing operation is complete, the protection members 34 and 35 have moved to a position at which they completely cover the opening portion of the protection cover 30. As a result, the state in which the protection unit 3 is in the closed position as shown in FIG. 14 is realized, and the protection unit 3 can protect the speaker unit 2 as shown in FIG. 2.

Although a description of the automatic opening/closing of the protection unit 8 according to Embodiment 2 has been omitted, automatic opening and closing of the protection unit 8 can be realized by, similarly to as in Embodiment 3, providing an open position detection switch and a closed position detection switch that detect the opening and closing of the protection member 81.

Although the enclosure 1 of the speaker apparatus 5 of the present invention has been described as being spherical or cubical, the present invention is also applicable in the case of an enclosure that has continuous faces, a polyhedron, and the like. In other words, the outer surface of the protection unit and the surrounding outer surface of the enclosure can be made (substantially) continuous in the open position (so not protruding or recessed with respect to the enclosure).

Also, although the protection members 34 and 35 are opened and closed with use of springs, wires, and gears in Embodiments 1 to 3 described above, another mechanism such as a linkage mechanism may be applied.

According to Embodiments 1-3, in the speaker apparatus the opening rate is 100% during use (so the speaker unit is not obscured or obstructed during use), and the speaker is protected during non-use, without the occurrence of sound diffraction, and without influence on the sound quality.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-124722, filed May 22, 2009, which is hereby incorporated by reference herein in its entirety.

What is claimed is:

1. A speaker apparatus comprising:
a speaker unit arranged to output sound to the exterior of the speaker apparatus via an opening;
an enclosure containing the speaker unit; and
a protection units, supported by the enclosure, for protecting the speaker unit, wherein the protection units includes a protection member for at least partially covering the opening, and wherein
the apparatus comprises a moving unit for changing the distance between the enclosure and the protection units and wherein the protection units is configured such that the position of the protection member changes with respect to the opening in accordance with a change in the distance between the enclosure and the protection units.

2. The speaker apparatus according to claim 1, wherein the moving unit is arranged to move the protection units to project externally of the enclosure.

3. The speaker apparatus according to claim 1, wherein the moving unit is configured to move the protection units from a first position, in which the opening is unobstructed by the protection member, to a second position in which the opening is at least partially obstructed by the protection member.

4. The speaker apparatus according to claim 1, wherein upon operation of the moving unit to increase the distance between the enclosure and the protection units, a position of the protection member is moved from an open position, in which the protection member maintains an open state of the opening so as to not block the output sound, to a closed position in which the protection member completely covers the opening.

5. The speaker apparatus according to claim 4, further comprising:
a linkage mechanism linking the protection member and the enclosure, for moving the protection member between the open position and the closed position in accordance with an increase in the distance between the enclosure and the protection units.

6. The speaker apparatus according to claim 5, wherein the linkage mechanism comprises an elongate connection member connected at one end to the protection member and at the other end to the enclosure such that the protection member is pulled from the open position to the closed position as the distance between the enclosure and the protection units increases.

7. The speaker apparatus according to claim 5, wherein the linkage mechanism comprises rotatable unit configured to rotate the protection member between the open position and the closed position as the distance between the enclosure and the protection units increases.

8. The speaker apparatus according to claim 1, further comprising a power supply for supplying power to the moving unit.

9. The speaker apparatus according to claim 3, wherein an outer surface of the protection units and a corresponding outer surface of the enclosure are substantially continuous when the protection units is in the open position.

10. The speaker apparatus according to claim 1, wherein the protection units forms a portion of a face of the enclosure containing the opening in which the speaker unit is mounted.

11. The speaker apparatus according to claim 1, wherein the protection units further comprises a protection cover and the opening portion is provided in the protection cover.

12. The speaker apparatus according to claim 1, wherein the protection units comprises two protection members.

13. The speaker apparatus according to claim 1, comprising two protection units each comprising a protection member.
